(19) United States
(12) Patent Application Publication
(10) Pub. No.: US 2025/0341314 A1
(43) Pub. Date: Nov. 6, 2025

(54) COOKING APPLIANCE WITH PROJECTED DISPLAY

(71) Applicant: The Steelstone Group LLC, Brooklyn, NY (US)

(72) Inventors: Naphtali H. Biegeleisen, Brooklyn, NY (US); Binyumen Itzkowitz, Brooklyn, NY (US); Meilech Friedman, Linden, NJ (US); Kalman Wertzberger, Brooklyn, NY (US); Robyn De Luca, Queens, NY (US); Wenhui Huang, Brooklyn, NY (US); Joseph Deutsch, Brooklyn, NY (US)

(21) Appl. No.: 19/196,530

(22) Filed: May 1, 2025

Related U.S. Application Data
(60) Provisional application No. 63/641,716, filed on May 2, 2024.

(51) Int. Cl. F24C 7/08; A47J 37/06; F24C 15/00; F24C 15/32

(52) U.S. Cl. CPC F24C 7/08; A47J 37/0641; F24C 15/004; F24C 15/322

(57) ABSTRACT

A cooking appliance includes a housing enclosing an inner cooking chamber, an airflow conduit for directing air from a first location within the inner cooking chamber to a second location within the inner cooking chamber, an airflow generator for generating airflow within or adjacent the airflow conduit, and a viewing window in a top surface of the housing. The viewing window provides at least a partial view of the inner cooking chamber. A heating element is at least partially within the airflow conduit, such that air removed from the first location within the inner cooking chamber is returned to the second location within the inner cooking chamber only after passing the heating element.

### CROSS REFERENCE TO RELATED APPLICATIONS

This application takes priority from Provisional Patent Application No. 63/641,716, filed May 2, 2024, the contents of which are incorporated by reference herein.

### FIELD OF THE INVENTION

This invention generally relates to food cooking appliances, and more particularly to cooking appliances incorporating projected displays, thereby providing views of an internal space of the cooking appliance unobstructed by a display.

### BACKGROUND

Cooking appliances, including air fryers are very popular. However, many cooking appliances, such as air fryers, have fully enclosed structures in which it is difficult or impossible to view food within the air fryer while the food is cooking.

Cooking appliances are typically insulated, and therefore have thick walls, and they often include electronics and/or heating elements embedded into the housing of the appliance. For example, air fryers typically include heating elements and/or fans incorporated into a top portion of the appliance, and therefore the top portion cannot be made transparent.

Additionally, air fryers typically include substantial control panels and displays that cover significant portions of the housing, and such portions of the housing therefore cannot easily be made transparent. Further, a portion of the air fryer above a cooking chamber often incorporates heating electronics, in addition to control electronics, creating additional challenges in incorporating transparencies into the device.

Existing air fryers that include some transparent section are therefore limited to a window in a front surface of the appliance, such as a window incorporated into a drawer.

There is a need for a cooking appliance, such as an air fryer, that can allow for a panoramic view of food within an inner cooking chamber while the food is cooking.

### SUMMARY

A cooking appliance is provided, the cooking appliance including a housing enclosing an inner cooking chamber, an airflow conduit for directing air from a first location within the inner cooking chamber to a second location within the inner cooking chamber, an airflow generator for generating airflow within or adjacent the airflow conduit, and a viewing window in a top surface of the housing. The viewing window provides at least a partial view of the inner cooking chamber. A heating element is at least partially within the airflow conduit, such that air removed from the first location within the inner cooking chamber is returned to the second location within the inner cooking chamber only after passing the heating element.

In some embodiments, the second location within the inner cooking chamber is adjacent a top surface of the housing and the first location is adjacent a bottom surface of the housing, and wherein the airflow conduit is adjacent a sidewall of the housing, and wherein the airflow conduit does not obstruct a view of the inner cooking chamber through the viewing window.

In some such embodiments, the viewing window is in a first portion of the top surface of the housing, and the second location within the inner cooking chamber is adjacent a second portion of the top surface of the housing.

In some such embodiments, the first portion of the top surface is adjacent a front wall of the housing, and the second portion of the top surface is adjacent a back wall of the housing, and the airflow conduit is adjacent a back surface of the housing. In some such embodiments, the cooking appliance also has a control panel opposite the second location on an outer surface of the second portion of the top surface.

In some embodiments having first and second portions of the top surface, the cooking appliance also has a secondary internal chamber between the viewing window and the inner cooking chamber, and an at least partially transparent panel divides the inner cooking chamber from the secondary internal chamber.

In some such embodiments, the cooking appliance further includes a projector for projecting a display within the secondary internal chamber, such that projected content appears within the secondary internal chamber. In some such embodiments, the projected content is projected onto the at least partially transparent panel.

In some such embodiments, at least a portion of an upper surface of the at least partially transparent panel has a dark color coating, the portion corresponding to a location at which the projected content is projected.

In some embodiments including a projector, an orientation of the at least partially transparent panel is selected to accommodate the projected content.

In some embodiments having a secondary internal chamber, the at least partially transparent panel is clear glass.

In some embodiments having a secondary internal chamber, the viewing window extends from the first portion of the top surface to a portion of a front surface of the housing, such that the viewing window provides a panoramic view of the inner cooking chamber.

In some embodiments, the heating element is fully within the airflow conduit.

In some embodiments, the heating element is at least one tubular heating element in the path of airflow within the airflow conduit.

In some embodiments, the airflow generator is a fan. In some such embodiments, the airflow generator is a cross-flow fan.

In some embodiments, the cooking appliance includes a cooking basket slidably removable from the inner cooking chamber, and the cooking basket slides out of inner cooking chamber by way of a front wall of the housing.

In some such embodiments, the cooking basket has an opening located such that the opening is adjacent the first location within the inner cooking chamber when the cooking basket is located within the inner cooking chamber.

In some embodiments using a cooking basket, the cooking basket is integrated into the front wall of the housing, such that the front wall of the housing and the cooking basket are removed from the inner cooking chamber together.

In some embodiments, the cooking appliance is an air fryer.

### BRIEF DESCRIPTION OF THE DRAWINGS

FIG. 1 is a perspective view of a cooking appliance in accordance with this disclosure.

FIG. 2 is a front view of the cooking appliance of FIG. 1.

FIG. 3 is a section view of the cooking appliance of FIG. 1.

FIG. 4 is a perspective section view of the cooking appliance of FIG. 1.

FIG. 5 is a front top perspective view of the cooking appliance of FIG. 1 in use.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

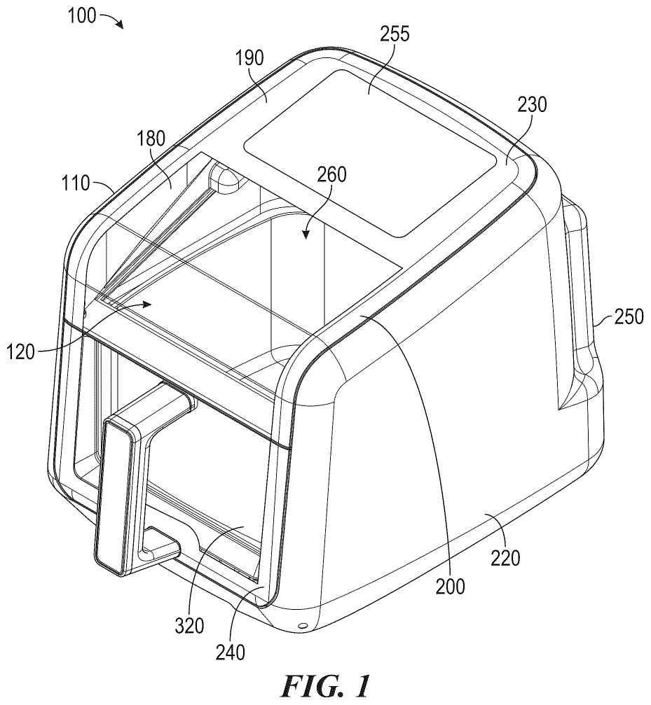

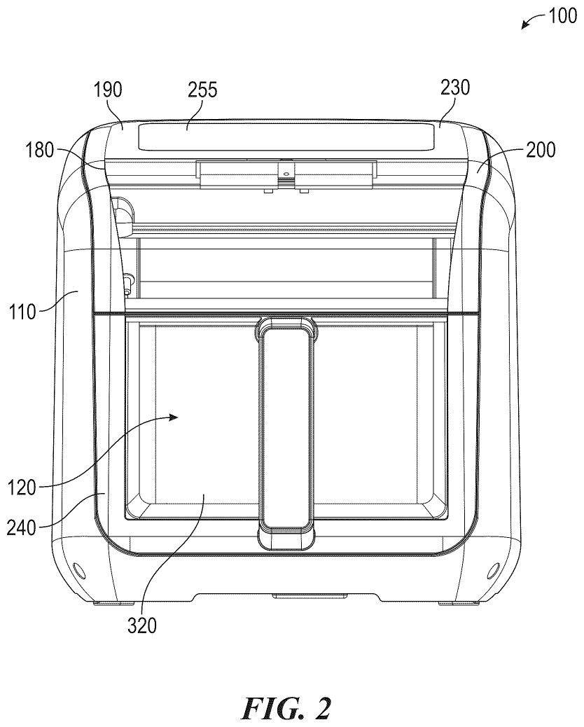

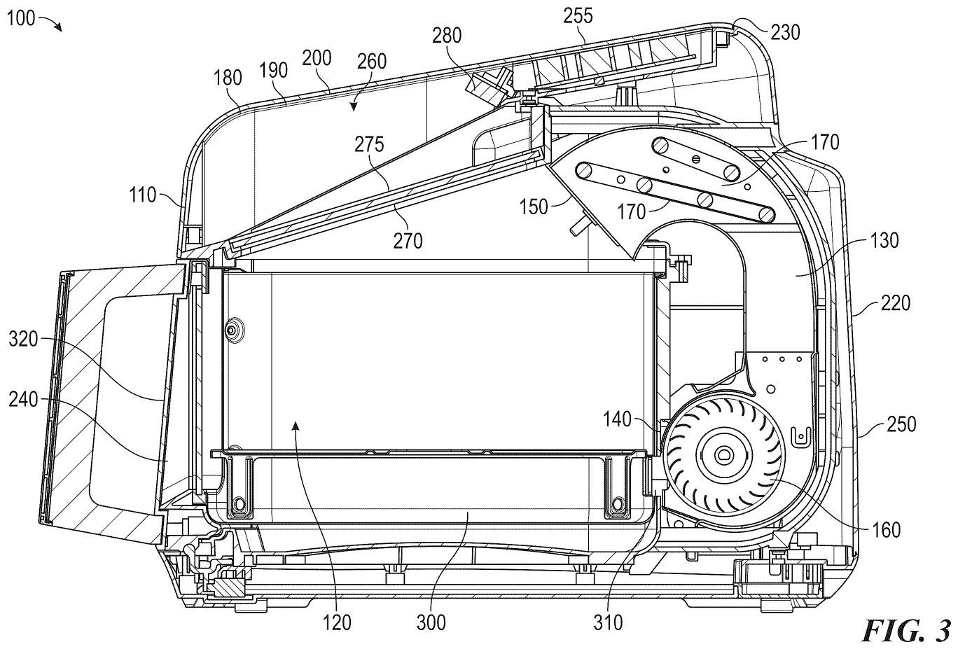

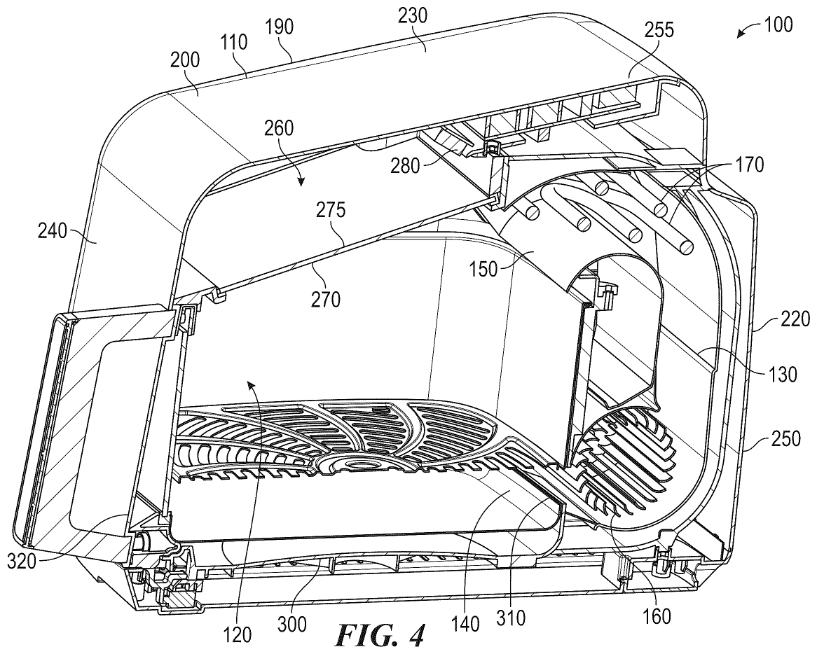

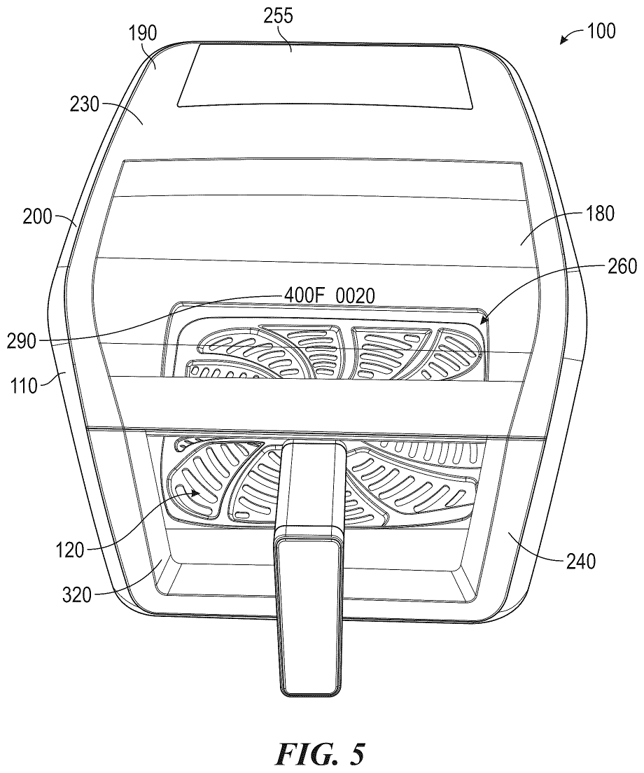

FIG. 1 is a perspective view of a cooking appliance 100 in accordance with this disclosure. FIG. 2 is a front view of the cooking appliance 100 of FIG. 1. FIG. 3 is a section view of the cooking appliance 100 of FIG. 1. FIG. 4 is a perspective section view of the cooking appliance 100 of FIG. 1. FIG. 5 is a front top perspective view of the cooking appliance 100 of FIG. 1 in use.

The cooking appliance 100 shown includes a housing 110 enclosing an inner cooking chamber 120. The inner cooking chamber 120 is most clearly visible in the section views of FIGS. 3 and 4. In the embodiment shown, the cooking appliance 100 is an air fryer.

The cooking appliance 100 further includes an airflow conduit 130 for directing air from a first location 140 within the inner cooking chamber 120 to a second location 150 within the inner cooking chamber. As shown, an airflow generator 160, such as a fan, is provided within or adjacent the airflow conduit 130. Such a fan 160 may be, for example, a cross-flow fan. The location of such a fan is important to the extent that it can be used to generate airflow within the conduit 130. Accordingly, the airflow generator 160 may be adjacent the generator but used to circulate air by way of the conduit 130.

During use, the conduit 130 removes air from the first location 140 within the inner cooking chamber 120 and deposits it back into inner cooking chamber at the second location 150, thereby generating a circulating airflow that passes over food located within the inner cooking chamber. By heating this airflow, the food within the inner cooking chamber 120 is quickly cooked by the circulating air.

In the embodiment shown, the second location 150 is adjacent a top surface 190 of the housing 110 and the first location 140 is adjacent a bottom surface 210 of the housing. The airflow conduit 130 is adjacent a sidewall 220 of the housing 110. In this way, the air is removed from a bottom of the inner cooking chamber 120 and returned to a top of the inner cooking chamber, and the airflow then circulates from top to bottom within the inner cooking chamber.

The cooking appliance 100 further includes a heating element 170 at least partially within the airflow conduit 130. Accordingly, the air removed from the first location 140 is returned to the inner cooking chamber 120 only after passing the heating element 170. This results in the airflow itself being heated, such that the moving air cooks any food present efficiently. Further, as shown, the terminating end of the conduit 130 may be angled downwards, such that airflow is naturally directed downwards towards any food in the inner food chamber 120.

In some embodiments, as shown, the heating element 170 may be fully within the airflow conduit 130, such that air flowing through the conduit is forced across the heating elements. The heating element may be at least one tubular heating element 170 in the path of the airflow within the airflow conduit. As shown, multiple elements 170 may provided, such that more of the airflow passes across the heating elements.

Further, as shown most clearly in FIG. 4, the airflow generator 160 may be a cross-flow fan extending across a width of the inner cooking chamber 120. The conduit 130 may then extend across a width of the sidewall 220 it is adjacent, and the first and second locations 140, 150 within the inner cooking chamber 120 may then similarly extend across a width of the cooking appliance 100. The heating elements 170 may similarly extend across the width of the cooking appliance 100 such that, in use, a horizontal sheet of air flows through the conduit 130, driven by the cross-flow fan 160, such that a large area across a surface of any food within the inner cooking chamber 120 is in contact with the heated and moving airflow.

As shown, the cooking appliance 100 also includes a viewing window 180 in a top surface 190 of the housing 110. The viewing window 180 provides at least a partial view of the inner cooking chamber.

As discussed above, the second location 150 where the airflow conduit 130 deposits air within the inner cooking chamber 120 is adjacent a top surface 190 of the housing 110. However, the airflow conduit 130 is located such that it does not obstruct a view of the inner cooking chamber 120 through the viewing window. For example, in the embodiment shown, the viewing window 180 is in a first portion 200 of the top surface 190 and the terminating end of the conduit 130 is adjacent a second portion 230 of the top surface 190. The second location 150 adjacent the terminating end of the conduit is then adjacent the second portion 230 of the top surface 190.

For example, the viewing window 180, and the corresponding first portion 200 of the top surface 190 may be adjacent a front wall 240 of the housing 110, while the second portion 230 of the top surface 190 may be adjacent a back surface 250 of the housing. Accordingly, the conduit 130 may run from the bottom surface 210 to the top surface 190 of the housing 110 along the back surface 250 of the housing, with the back surface being one of several potential sidewalls 220 of the housing.

Accordingly, the viewing window 180 may be on a front portion 200 of the top surface 190, and in some embodiments, such as that shown, the viewing window may extend from the first portion of the top surface to the front wall 240 of the housing 110, thereby providing a panoramic view of the inner cooking chamber 120.

The viewing window 180 may then be absent from the second portion 230 of the top surface 190, and as such the cooking appliance 100 may further include a control panel 255 opposite the second location 150 on an outer surface of the second portion 230 of the top surface 190.

The cooking appliance 100 may further include a secondary internal chamber 260 between the viewing window 180 and the inner cooking chamber 120. An at last partially transparent panel 270 may then divide the inner cooking chamber 120 from the secondary internal chamber 260. The cooking appliance 100 may then further include a projector 280 for projecting a display 290 within the secondary internal chamber 260. The projected content 290 would then appear within the secondary internal chamber 260. For example, the projected content 290 may be projected onto the at least partially transparent panel 270. In such an embodiment, an orientation of the at least partially transparent panel 270 may be selected to accommodate the projected content.

The at least partially transparent panel 270 may then be formed from clear glass, and may be made transparent. Accordingly, any food within the inner cooking chamber 120 may be visible through the viewing window 180, and when viewing the food, the projected content of the display 290 would appear to float within the panoramic view of the cooking chamber 110.

In some embodiments, an upper surface 275 of the partially transparent panel 270 may have a coating to improve the quality of content projected onto its surface. For example, the upper surface 275 may be printed or otherwise coated with a thin layer of dark ink or paint, such as black paint. Such an approach may be invisible or minimally visible when a user views the inner cooking chamber 120 through the secondary internal chamber 260. However, this may avoid issues such as ghosting or other artifacts of a display partially passing through the upper surface 275 that would otherwise interfere with the clarity of the display.

As shown, the design of the housing 110 may be selected to enhance the effect of the floating display 290 and the panoramic view of the inner cooking chamber 120 through the viewing window 180. Accordingly, the top surface 190 may be sloped downwards towards the front wall 240, and the viewing window extends across both the top surface and the front wall.

The cooking appliance 100 may further include a cooking basket 300 slidably removable from the inner cooking chamber 120. The cooking basket 300 slides out of the inner cooking chamber 120 by way of the front wall 240 of the housing 110.

The cooking appliance 100 may be an air fryer, and the cooking basket 300 may be similar to cooking baskets associated with air fryer designs. However, in some embodiments, the cooking basket 300 may have an opening 310 located such that the opening is adjacent the first location 140 within the inner cooking chamber 120 when the cooking basket is located within the inner cooking chamber. In this way, the airflow generator 160 may more efficiently draw airflow from a lower portion of the cooking basket 300 and redirect the airflow towards the top of the inner cooking chamber 120. As discussed above, the airflow conduit 130 and related components may extend horizontally, and as such, the opening 310 in the cooking basket may similarly extend horizontally within the inner cooking chamber 120.

In some embodiments, the cooking basket 300 may be integrated into the front wall 240 of the housing 110, such that the front wall and the cooking basket are removed from the inner cooking chamber 120 together. Further, the front wall 240 of the cooking chamber may be provided with a secondary viewing window 320 which can further extend the primary viewing window 180 and further enhance the panoramic effect of the view of the inner cooking chamber 120.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A cooking appliance comprising:
a housing enclosing an inner cooking chamber;
an airflow conduit for directing air from a first location within the inner cooking chamber to a second location within the inner cooking chamber;
an airflow generator for generating airflow within or adjacent the airflow conduit;
a viewing window in a top surface of the housing, such that the viewing window provides at least a partial view of the inner cooking chamber, and
a heating element at least partially within the airflow conduit, such that air removed from the first location within the inner cooking chamber is returned to the second location within the inner cooking chamber only after passing the heating element.

2. The cooking appliance of claim 1, wherein the second location within the inner cooking chamber is adjacent a top surface of the housing and wherein the first location is adjacent a bottom surface of the housing, and wherein the airflow conduit is adjacent a sidewall of the housing, and wherein the airflow conduit does not obstruct a view of the inner cooking chamber through the viewing window.

3. The cooking appliance of claim 2, wherein the viewing window is in a first portion of the top surface of the housing, and wherein the second location within the inner cooking chamber is adjacent a second portion of the top surface of the housing.

4. The cooking appliance of claim 3, wherein the first portion of the top surface is adjacent a front wall of the housing, and wherein the second portion of the top surface is adjacent a back wall of the housing, and wherein the airflow conduit is adjacent a back surface of the housing.

5. The cooking appliance of claim 4 further comprising a control panel opposite the second location on an outer surface of the second portion of the top surface.

6. The cooking appliance of claim 3 further comprising a secondary internal chamber between the viewing window and the inner cooking chamber, wherein an at least partially transparent panel divides the inner cooking chamber from the secondary internal chamber.

7. The cooking appliance of claim 6 further comprising a projector for projecting a display within the secondary internal chamber, such that projected content appears within the secondary internal chamber.

8. The cooking appliance of claim 7, wherein the projected content is projected onto the at least partially transparent panel.

9. The cooking appliance of claim 8, wherein at least a portion of an upper surface of the at least partially transparent panel has a dark color coating, the portion corresponding to a location at which the projected content is projected.

10. The cooking appliance of claim 8, wherein an orientation of the at least partially transparent panel is selected to accommodate the projected content.

11. The cooking appliance of claim 6, wherein the at least partially transparent panel is clear glass.

12. The cooking appliance of claim 6, wherein the viewing window extends from the first portion of the top surface to a portion of a front surface of the housing, such that the viewing window provides a panoramic view of the inner cooking chamber.

13. The cooking appliance of claim 1, wherein the heating element is fully within the airflow conduit.

14. The cooking appliance of claim 1, wherein the heating element is at least one tubular heating element in the path of airflow within the airflow conduit.

15. The cooking appliance of claim 1, wherein the airflow generator is a fan.

16. The cooking appliance of claim 15, wherein the airflow generator is a cross-flow fan.

17. The cooking appliance of claim 1 further comprising a cooking basket slidably removable from the inner cooking chamber, wherein the cooking basket slides out of inner cooking chamber by way of a front wall of the housing.

18. The cooking appliance of claim 17, wherein the cooking basket has an opening located such that the opening is adjacent the first location within the inner cooking chamber when the cooking basket is located within the inner cooking chamber.

19. The cooking appliance of claim 17, wherein the cooking basket is integrated into the front wall of the housing, such that the front wall of the housing and the cooking basket are removed from the inner cooking chamber together.

20. The cooking appliance of claim 1, wherein the cooking appliance is an air fryer.
